(19) United States
(12) Patent Application Publication
(10) Pub. No.: US 2007/0219940 A1
(43) Pub. Date: Sep. 20, 2007

(54) Merchant Tool for Embedding Advertisement Hyperlinks to Words in a Database of Documents

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: Leviathan Entertainment, LLC, Santa Fe, NM (US)

(21) Appl. No.: 11/697,437

(22) Filed: Apr. 6, 2007

Related U.S. Application Data
(63) Continuation-in-part of application No. 11/668,596, filed on Jan. 30, 2007.
(63) Continuation-in-part of application No. 11/668,586, filed on Jan. 30, 2007.
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/1

(57) ABSTRACT

A database, such as a patent database, including a plurality of electronic documents, such as patents and patent applications, is described. The documents include words, phrases, and/or pictures that have been hyperlinked to advertisements or other documents. Also described are methods of indexing words and phrases in the documents and allowing advertisers, merchants, or other entities to pay for the right to hyperlink selected words, phrases, pictures that appear in the documents in the database to web-based documents of their choosing.

### CROSS REFERENCE TO RELATED APPLICATIONS

The present application is a continuation in part of U.S. patent application Ser. No. 11/668,596, “Keyword Advertising in Invention Disclosure Documents” filed Jan. 30, 2007, Ser. No. 11/668,586; “Targeted Advertising Based on Invention Disclosures” filed Jan. 30, 2007; and Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

The internet allows people to access enormous amounts of information in a fast and efficient manner. Frequently, large numbers of related or unrelated documents are maintained in searchable databases, which users can access in order to find information of interest. An example of such a database includes the USPTO Patent and published patent application databases. Databases may be publicly or privately available and may or may not charge a fee for access. As the availability of information over the internet grows, advertisers continue to search for new ways to provide advertising to those consumers who seem more likely to be interested in their products. This decreases advertising costs, allowing merchants to increase revenue and pass savings on to consumers. Accordingly methods and systems to take advantage of the self-selectivity of database users by providing directed advertising to potential consumers based on the items viewed in a database would be advantageous.

### DETAILED DESCRIPTION

According to one embodiment, the present disclosure provides a mechanism whereby merchants or other entities can purchase the right to hyperlink predetermined words or phrases that appear in a database of documents. The hyperlinked words or phrases may then direct a user who selects the hyperlink to a site, document, location etc. of the merchant's choosing. For example, a chemical manufacturer may choose to hyperlink each instance of the term “NaCl” that appears in a database of scientific journal articles to a catalog webpage featuring the chemical manufacturer's commercially available sodium chloride.

According to one embodiment, a database of documents or words, such as the patents included in the USPTO patent office database is analyzed and, optionally, divided into classes and subclasses that preferably relate to the classes and subclasses of documents in the database. Words, particularly nouns and verbs, are counted and an index and/or hyperlink for each may be generated and stored.

A user interface such as a web based tool or other application is then provided wherein a merchant or other entity can log in to the tool and indicate the type of documents, words or other elements, e.g., figures and figure components, in which the merchant is generally interested. The merchant may indicate an interest in any one or more documents or words and choose to add one or more hyperlinks to be associated with such words. Such web based tool may permit the merchant to generate or assign hyperlinks to a single database, e.g., the USPTO database, or multiple databases.

In the event that a merchant is interested in more than one word (or phrase), the tool may be configured such that the merchant(s) can provide the system with a prioritized list of the words (or phrases) of interest.

In certain embodiments, merchants may desire to display advertisements for words and/or one or more of any or all such words' synonyms and/or antonyms and/or any related figures. Exemplary methods to determine relevant synonyms and/or antonyms to use for such associations are disclosed by applicants in U.S. Patent Application No. ______ (Attorney Docket No. 3303104 entitled “Thesaurus Created from Merchant Keyword Purchases,” filed Apr. 6, 2007, which is incorporated by reference. In certain embodiments, words include synonyms and/or antonyms as applicable/desired.

According to an embodiment, merchants can offer to pay to have one or more hyperlinks, advertisements and/or notes associated with one or more words and/or any one or more words' synonyms and/or antonyms. For example, a merchant that sells batteries may be interested in the words: battery, batteries, electricity, electrical, electrical storage devices, chemical energy, electrical energy, power cell, standby power, among others. The merchant may choose to pay a fee to generally associate a hyperlink with any one or more of such words. The merchant may be willing to pay a higher fee for a certain word or words, e.g., battery, or group of words, e.g., battery, batteries and Duracell, while he may be less willing to pay or only willing to pay a lesser amount for other certain words, e.g., chemical energy device. In such cases, the merchant may opt to pay a higher fee for certain words and a lower fee for other words. Methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

In certain embodiments, a merchant may pay the same amount for creating a link to any or all words, and/or one or more synonyms and/or antonyms or other documents. In other embodiments, the fee may be determined by any applicable means, such as one or more of the following, including, but not limited to: the number or type of documents, words, synonyms, antonyms, figures, attachments, and/or the type of hyperlink, e.g., an ad versus a short description hyperlink vs. an ad plus right click options, whether or not the end user clicks, right clicks, reads the popup ad or takes other actions, e.g., fills out a form, buys a product, takes a test drive, performs a task, provides information about himself or others, etc. Fees may be fixed or variable or both. Fees may be additive or limited. Merchants may establish a budget or other payment rules.

In another embodiment, the merchant may wish to indicate the type of documents that he's interested in. For example, a merchant that sells batteries may wish only to include hyperlinks in patent documents (issued and pending) that belong to a certain field of use or class, e.g., electrical devices or consumer products, etc. By restricting hyperlinks to certain classes of documents, the merchant may avoid paying for hyperlinks associated with words within documents of little interest, e.g., spacecraft, in which case, the merchant may not have products that satisfy such a specialized field.

Methods to create web pages, hyperlinks and hypertext and/or advertisements and/or notes are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which are hereby incorporated by reference.

In another embodiment, the merchant may select a group of documents and view the counts of words by individual document, document class, and document subclass. The merchant can select a word in one or more documents, document classes and document subclasses and pay to have that word hyperlinked to an advertisement, such as a popup ad, interstitial ad, or a webpage (which may open another window, or redirect the user or provide an option to the user) and/or take other action(s), such as requesting the end-user to fill out a survey.

In the event that multiple merchants are willing to pay for a hyperlink to one or more words, the system may provide a generic hyperlink whose actions are determined prior to or generally at the time of use. For example, if two battery manufacturers desire hyperlinks to be associated with the word battery, when an end user, for example, clicks on the word battery, any one or more of the following may occur including: 1) the system may ask the end user to provide additional information about the request for information, e.g., the system may ask the end user to fill out a survey or answer one or more questions, e.g., Are you interested in commercial or household use batteries?, 2) the system may determine which merchant's ad, the order of the ads, or other action to take based upon any one or more of the following, including: a) the price paid or that would be paid by one or both merchants, b) information about the document or the end user, c) a comparison of information about the end user and/or merchant and/or document and/or word(s), d) a selection provided by the end user, e.g., making a choice after right clicking a word and then selecting from a menu of choices, e.g., receive more information, display website, order now, etc.

Once the merchant has selected one or more words and created or otherwise indicated or provided the hyperlink to an advertisement, webpage, additional information, survey, or other action step, end users who search the database of documents can see the hyperlinks of the words in the database to the merchant's advertisements, web pages, additional information, or survey or other actions. End users may then choose to activate any one or more of the hyperlinks, as they wish. In addition or in the alternate, such hyperlinks may be automatically activated without end user intervention, permission or action. For example, when an end user views a given document, word, phrase, figure or image, the disclosed system may automatically activate one or more hyperlinks associated with such document, word, phrase, figure or image. This method may prove useful, for example, in systems where end users are provided access for free or for a reduced fee if they agree (e.g., opt in) to view one or more advertisements in exchange for such usage.

In certain embodiments, a server application is provided to permit: 1) the analyzing of documents across many servers, web pages, databases, etc., 2) merchants or other interested third parties to indicate which a) words, synonyms, antonyms, figures, images, documents, types or classes or subclasses of documents, etc., that the merchant would be interested in generally or providing a hyperlink, and/or 3) end users can visit as a starting or mid-point to enter or search for words and receive a list of one or more hyperlinks based upon such entry or search and, which search may be determined by any applicable means, including, any one or more of: i) use of any existing or known search algorithm, ii) based upon merchant payments and/or end user profile preferences, iii) responses to one or more survey questions by merchants and/or end users; iv) past searches conducted by the end user, v) actions taken in response by such end users, e.g., the purchase of a product or use of certain information, or feedback by the end user, e.g., a follow-up survey and/or any combination of the forgoing.

Methods to provide for such survey questions and gathering of data are disclosed by applicants in U.S. Patent Application Ser. No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

Methods to search, web crawl, index or otherwise examine the Internet and World Wide Web are well known within the prior art. For example, such methods are disclosed and discussed in the following reference materials and books, including: “Mining the World Wide Web—An Information Search Approach (The Kluwer International Series on Information Retrieval, Volumes 1-10) (The Information Retrieval Series) by George Chang, Marcus Healey, and James A. M. McHugh and “Google's PageRank and Beyond: The Science of Search Engine Rankings,” by Amy N. Langville, Carl D. Meyer, and “Internet Searching and Indexing: The Subject Approach, by Alan R. Thomas and James R. Shearer (Editor),”

According to yet another embodiment, merchants may opt to hyperlink all or only some occurrences of words, synonyms, antonyms, documents, figures and/or images. In certain embodiments, for example, one or more merchants may opt to hyperlink or otherwise be associated with specific words or phrases. Merchants and/or the system may determine which words to associate with which merchants. Such determination may be made by any applicable means, including, any one or more of the following, such as: the total count of a word or words in a document, the relevancy of the document and/or the context or use of the word or words to the merchant's line of business or other interest, the relevancy of the database or class, sub-class or other category of the database and/or document and/or paragraph and/or word or words and/or the context of the sentence or paragraph in which the word or words were used, or any other variable or condition, for example, a merchant may indicate interest based upon the level of interest shown or willingness to pay for any given word or words of one or more of the merchant's competitors, and/or the success of the merchant and/or any one or more of merchant's competitors based upon hyperlinks associated with the same or similar words, e.g., synonyms, within the same or similar documents and/or within the same or similar database, category or class or sub-class of documents and/or databases. In yet other embodiments, such relevancy may be determined, in whole or in part, through the use of automated means. In addition to the novel relevancy methods disclosed herein, other methods to determine relevancy between and among documents and/or websites are well known within the prior art, including, for example, the methods discussed in the book entitled “Text Databases and Document Management: Theory and Practice, by Amita Goyal Chin, which is hereby incorporated by reference.

In another embodiment, merchants may rank the priority of certain words, or the position of words within a given document. For example, if the word appears early in a document, e.g., a patent title, or in an index of a user manual, a merchant may be willing to pay a higher or lower or no amount for such word positioning.

In certain embodiments, merchants may limit their advertising exposure. Such limitations may or may not take into account the “conversion rate” of those clicking on one or more links. For example, a merchant might indicate that the total budget for advertisements associated with documents in the USPTO patent database should be limited to $5,000 per month. Such Merchant may add a stipulation or exception to such rule, e.g., “unless revenues greater than $50,000 are generated as a result of end users clicking on such words/hyperlinks.” In this way, the total amount a given merchant is willing to spend may be based in whole or in part upon the general effectiveness of such advertising/hyperlinks. Limitations may be established or determined by any applicable means, including, for example, total costs per use, click, click through, conversion, day, week, month, year, maximum amount for the life of the document or word, limits based upon competitive influences, success rates, frequency and type of changes to the word, words, paragraphs, documents, databases or any other variables, and any combination of the forgoing, including any changes in trends or rates of change, or newly emerging trends, e.g., a sudden or other increase in click through using similar words or the same words elsewhere within the document and/or the database and/or generally. The system may monitor any available or applicable data, including usage rates, click through rates, sales, failure to close sales, sales or success of the merchant and/or any one or more of merchant's competitors, and/or results known or gathered regarding the same or similar results within one or more search engines or other advertising systems, any or all of which may be used in any combination to determine the amount a merchant is willing to pay or budget for payment for advertising, which limits may be fixed or variable or a combination of fixed and variable amounts.

In addition to purchasing the word as a hyperlink, the merchant can also purchase a brief text description of the word, i.e. for the word CPU, the advertiser could select, “such as the Centrino manufactured by Intel” as a text description that is added to the word everywhere it is listed in a document. End users who search the database could elect to hide or show these brief text descriptions along with the original text of the document(s). Or, users could elect to have such descriptions (short or long) appear as comments when the user positions their cursor over or near the hyperlinked word or phrase or right clicks on the hyperlinked word or phrase.

In yet another embodiment, merchants can bid to have their advertisement presented if a hyperlinked keyword is clicked by an end user. If multiple merchants are bidding on the word, the hyperlink, when clicked, can show a list of advertisers in the order of highest to lowest bidder, and/or the highest bidder's link appears more often than other bidders and/or uses a different text font or color and/or an icon, such as a logo, could appear for the highest bidder. In another embodiment, those that are competing for the same noun (for example), might have their hyperlinks associated with the noun for some frequency other than 100% of the time. The link appearance or frequency might be based upon the price paid, the relative price paid, i.e., as compared with all others vying for the same noun, randomly, in order, i.e., highest paid fee appears first, second highest fee paid appears secondly, and so on. Such preferential display may affect all of the same nouns in a given document, or it may vary. For example, if Vendor A pays $0.05 per click through, and Vendor B pays $0.025. The system might display a hyperlink on all paid nouns, e.g., car, for 75% of the time (on all words that include “car”), while vendor B's link only appears 25% of the time (on the same words). In addition or in the alternate, Vendor A's link may appear on only 75% of the words, but is displayed all the time, while Vendor B's hyperlinks may only appear on 25% of the words with the letters “car”. In this fashion, the probability that an end user will click on Vendor A's hyperlink is 75%

In another embodiment, other factors can control the number and frequency of activated hyperlinks, including, but not limited to: Total vendors/third parties that have purchased or are vying for the right or otherwise desire to include one or more hyperlinks, total number of words linked, success or click through rates, success of sales, quantity or quality of information gathered via one or more surveys or any other applicable means or any combination of the forgoing.

Other possible hyperlink actions include: Option to indicate that the end user wishes to receive additional information, immediate or delayed: look up of a definition, synonym or antonym, popup of an ad, redirection to another website, which may or may not be provided via a separate browser page, skip to the next use of the word or part of the word or to another related or unrelated section within the current or other document or website, popup of a synonym or antonym (with an option to jump to any such synonym or antonym (if present) within the text or the merchant's website, replace the word with or add a description to the word, e.g., short or long description, or synonym or antonym or any other applicable options, and/or any one or more or combination of the forgoing.

According to some embodiments, the merchant can select more than one word and hyperlink that word to the same advertisement or web page. For instance, the merchant can select, “CPU” and “Processor.”

Examples of Document Databases that can offer this functionality include:
1. The patents issued and published by the USPTO
2. Other government databases
3. Product Reviews, e.g., consumer reports
4. User and technical manuals
5. Magazine and newspaper articles
6. Advertisements
7. Online books or encyclopedias
8. Libraries
9. Search engines

In another embodiment, in addition to or instead of words or phrases, merchants can select figures and link their advertisement or webpage to the figure.

In addition to purchasing keywords, keyword phrases or two or more words that are placed next to or near or in a specific position relative to each other or that both appear in a document can be purchased. For example the phrase “Web-Based Application” or the words “CPU” and “Video Game” can be purchased and used as hyperlinks to advertisements or web pages.

In certain embodiments, the selection of an appropriate hyperlink and/or fees may be determined based in whole or in part upon the actual usage or success or click through rates and/or amount of revenue generated by word, merchant, end user, server, database, document, document type or class, etc. Such a system could measure actual usage for each of the preceding characteristics and adjust or change which hyperlinks are in effect and/or modify fees for use of such hyperlinks so as to drive optimum results. Optimum results may mean and/or include any one or more of the following: 1) amount of revenue generated for the service that provides such hyperlinks, 2) amount of revenue received by merchants, 3) frequency that end users click through on such hyperlinks 4) percentage of end users that purchase the advertised product, view a demonstration, read information, take an action, respond to a survey, request a brochure or additional information, 5) conversion rates, and/or 6) relevancy or usefulness of hyperlinks as determined by the end user, or the system or the merchant or a combination of any one or more of the forgoing. In such a system, hyperlinks could be randomly tested to determine initial acceptance/usefulness, and/or they could be tested based upon initial revenue projections or merchant's willingness to pay or via any other applicable means, including, for example, use of a genetic algorithm or neural net to test and automatically optimize use of time.

In addition to appearing in documents in a database, words that are entered into a document drafting tool, or that are part of a lexicon or thesaurus associated with a search engine and or document drafting tool can also become hyperlinks that direct the searcher to advertisement and or merchant websites.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each of which are incorporated herein by reference.

In certain embodiments, end users may desire to search notes, words, documents or databases, for example, a patent database to find relevant notes, words, or documents, e.g., patents and/or prior art that may require lexicon updates and/or definitions, synonyms and/or antonyms. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and _______ (Attorney docket No. 3304103) entitled “Enhanced Patent Prior Art Search Engine,” filed Apr. 6, 2007; each of which is hereby incorporated by reference.

In other embodiments, end users may desire to file and/or update documents, e.g., patents, using web based tools via the Internet. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference. In other embodiments, end users may desire to prioritize the processing of their submissions, documents, notes, reviews, commentary or other tasks or items submitted to a queue. In such cases, methods to provide for prioritization are desirable. Exemplary methods for priority queuing documents are disclosed for example in U.S. patent application Ser. Nos. 11/462,621 11/462,621, “Fee-Based Priority Queuing for Insurance Claim Processing,” filed Aug. 4, 2006; Ser. No. 11/611,024 “System and Method for Prioritizing Items in a Queue” filed Dec. 14, 2006; and PCT Application No. PCT/US06/340347, “Insurance Form Priority Queuing;” each of which are incorporated herein by reference.

In certain embodiments, the disclosed invention may be applied to any database and/or multiple databases, for example, a database of books, such as that maintained by Amazon.com. In such cases, merchants or any person, company, business entity, charitable entity or other third parties may determine that hyperlinking one or more words, phrases, documents, or an entire databases may be desirable. In such cases, merchants or any person, company, business entity, charitable entity or other third parties, may provide an indication or rules or terms and conditions under which any one or more of the preceding entities may wish to purchase or agree to pay for or otherwise be associated with and/or control an association with or over any one or more such word, words, phrases, documents and/or hyperlinks and/or to establish a budget or rules regarding such budget for such use in determining which such entities would have use or control over, whether temporary or otherwise, any such hyperlinks.

In certain embodiments, the systems and methods of the present disclosure may be practiced in the real or virtual world or both. For example, a video game may include a repository or database of documents, for example, a virtual patent office or a collection of conversations typed or spoken in the virtual world.

Exemplary methods and systems for providing protection of intellectual property in a virtual environment are disclosed, for example, in U.S. patent application Ser. No. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference.

Accordingly, the disclosed invention may similarly be applied to a virtual environment, world or video game(s) or any combination of the forgoing. For example, advertisements, such as those disclosed herein, may be delivered in the virtual world. In such cases, methods to ensure that agreements are enforceable and that advertising fees are collected in such virtual environments are desirable.

Methods for providing such contract enforcement and collection of fees are disclosed, for example, in U.S. patent application Ser. No. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559158 “Financing Options in a Virtual World” filed Nov. 13, 2006; Ser. No. 11/620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In certain embodiments, before displaying an advertisement and/or before presenting a list of words and/or documents, e.g., from a lexicon of words, it may be desirable to ascertain certain additional information about such advertisement and/or request for information. In such cases, the system may determine that it is necessary, desirable or generally useful to present one or more survey questions to aid in determining which words, documents, or other information should be presented, e.g., to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of case to include legal cases, and/or the system may also provide an advertisement for one or more attorneys seeking clients. Based upon the response to one or more questions, the system may present additional qualifying questions, i.e., additional questions to further narrow the search results and or the sort display results.

Methods to provide for such survey questions and gathering of data are disclosed by applicants in U.S. patent application Ser. No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

In yet another embodiment, merchants or advertisers may wish to be notified upon the occurrence of certain events or conditions. Such events include: the acceptance or assignment or association of an advertisement with one or more documents or words, the use or activation of an advertisement, and/or one or more sales, total target or some other metric or objective, the availability of a formerly unavailable word or document for advertisement inclusion, or any other change in data or applications of interest to such merchant or advertiser. Such notifications may be made via any applicable means, e.g., and email or other message. Such methods to determine alert events and/or to send alerts are disclosed for example, in U.S. patent application Ser. No. 11/676,848 “Virtual Environment with Alerts” filed Feb. 20, 2007 which is incorporated herein by reference.

It will be appreciated that all embodiments herein which refer to a patent are equally applicable to a patent application, journal article, literary work, or other document, unless explicitly stated otherwise with respect to a particular embodiment. Any reference to a patent (or to a patent application) is for reasons of brevity alone.

It will be appreciated that all embodiments herein which refer to a system for real world documents such as patents can also apply to a system that manages virtual patent applications that are filed by players in a virtual environment such as second life.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:

| | |
|---|---|
| 1. | Advertisement Creation, Generation, Display and Tracking Program |
| 2. | Billing Program |

Exemplary databases architectures include:

| 1. | Word Database | |
|---|---|---|
| | a. | Word ID |

| | |
|---|---|
| 1. | Word Count ID |
| 2. | Word |
| 3. | Primary Definition |
| 4. | Hyperlinks 1-N (e.g., sources/locations of use) |
| 5. | Alternative Definitions 1-N |

| | |
|---|---|
| a. | Definition |
| b. | Supplied By-ID |
| c. | Hyperlinks 1-N |

| | |
|---|---|
| 6. | Synonym ID-1-N |

| | |
|---|---|
| a. | Synonym |
| b. | Word ID |
| c. | Relevancy Scores 1-N |
| d. | Primary Score % |
| e. | Alternative Score %'s 1-N |

| | |
|---|---|
| 7. | Antonym ID-1-N |

| | |
|---|---|
| a. | Antonym |
| b. | Word ID |
| c. | Relevancy Scores 1-N |
| d. | Primary Score % |
| e. | Alternative Score %'s 1-N |

| | |
|---|---|
| 8. | Notes 1-N |

| | |
|---|---|
| a. | Note ID |
| b. | Note Short Description |
| c. | Note Long Description |
| d. | Narrative Text |
| e. | Attachment Hyperlinks 1-N |
| f. | Where Used Hyperlinks 1-N |

| | |
|---|---|
| 9. | Figure IDs 1-N |
| 10. | Change Tracking ID 1-N |
| 11. | Notes 1-N |

| 2. | Change Tracking Database | |
|---|---|---|
| | a. | Change Tracking ID |
| | b. | Word ID |
| | c. | Change Type (e.g., Add, change, delete) |
| | d. | Change Description |
| | e. | Date/Time |
| | f. | User ID |
| | g. | Before Image |
| | h. | After Image |
| | i. | Relevancy or score |
| | j. | Notes 1-N |
| 1. | Figure Database | |
| | a. | Figure ID |
| | b. | Figure Description |
| | c. | Figure or Attachment |
| | d. | Submitted By ID |
| | e. | Source ID |
| | f. | Editor Application ID |
| | g. | Document/Patent Application Where Used ID 1-N |

| | |
|---|---|
| 1. | Hyperlinks 1-N |

| | h. | Notes 1-N |
|---|---|---|
| 2. | Document Database | |
| | a. | Document ID |

| | |
|---|---|
| 1. | Document Description |
| 2. | Document Owner ID |
| 3. | Hyperlinks (e.g., document locations) 1-N |
| 4. | Class 1-N |
| 5. | Subclass 1-N |
| 6. | Type 1-N |
| 7. | Subtype 1-N |
| 8. | Date/Time Stamps |

| | |
|---|---|
| a. | Submitted/Found/Indexed On |
| b. | Submitted/Found/Indexed By ID or Hyperlink |
| c. | Revised On 1-N |
| d. | Revised By 1-N |
| e. | Before Image 1-N |
| f. | After Image 1-N |

| | |
|---|---|
| 9. | Notes 1-N |

| 3. | Advertiser or Notes Owner Database | |
|---|---|---|
| | a. | Advertiser/Owner ID |
| | b. | Advertiser/Owner Name |
| | c. | Classes of Trade 1-N |
| | d. | Advertiser/Owner Financial Information |

| | |
|---|---|
| 1. | Billing Method ID |
| 2. | Credit Card Information |

| | |
|---|---|
| a. | Preferred Card Number |
| b. | Preferred Card Holder |
| c. | Preferred Card Type |
| d. | Name |
| e. | Expiration Date |
| f. | Security Code |

| | |
|---|---|
| 3. | Additional Cards 1-N |

| | |
|---|---|
| a. | Card Number |
| b. | Card Holder (e.g., Bank Name) |
| c. | Card Type (e.g., Visa) |
| d. | Name |
| e. | Expiration Date |
| f. | Security Code |

| | |
|---|---|
| e. | Advertiser/Note Owner Mailing Address |
| f. | Advertiser/Note Owner Rules Database |

| | |
|---|---|
| 1. | Rule ID 1-N |

| | |
|---|---|
| a. | Word(s)/Documents Applied To 1-N |

| | |
|---|---|
| i. | Rule Description |
| ii. | Rules 1-N |
| iii. | Billing Terms and Conditions ID 1-N |

| | |
|---|---|
| g. | Advertiser/Note Owner Attorney of Record |

| | |
|---|---|
| 1. | Attorney ID 1-N |

| | h. | Advertiser/Note Owner Qualifications 1-N |
|---|---|---|
| | i. | Notes 1-N |
| 4. | Advertiser/Note Owner Qualifications Database | |
| | a. | Qualification ID |
| | b. | Description |
| | c. | Qualification Type |
| | d. | Years Experience |
| | e. | Fields of Use Applicable 1-N |
| | f. | Notes 1-N |

| | |
|---|---|
| 5. | Attorney Database |

| | |
|---|---|
| 1. | Attorney ID |
| 2. | Name |
| 3. | Address |
| 4. | Description |

| | b. | Notes 1-N |
|---|---|---|
| 6. | Billing Terms and Conditions Database | |
| | a. | Billing Method ID |
| | b. | Billing Type |
| | c. | Description |
| | d. | Billing Frequency |
| | e. | Due by # days |
| | f. | Late by # days |
| | g. | Interest Rate Fixed |
| | h. | Interest Rate Variable |
| | i. | Interest Accrues after days |
| | j. | Notes 1-N |
| 7. | Accounts Receivable Database | |
| | a. | Advertiser/Note Owner ID |
| | | Total Amount Owed |
| | b. | Transaction Detail Records 1-N |

| | |
|---|---|
| 1. | Date of Transaction |
| 2. | Type |
| 3. | Advertisement ID |
| 4. | Word ID |
| 5. | Hyperlinks 1-N |
| 6. | Amount per impression or click through |

| | c. | Notes 1-N |
|---|---|---|
| 8. | Search Database | |
| | a. | Document ID |
| | b. | Document Location/Hyperlink |
| | c. | Notes 1-N |
| 9. | Transaction Database | |
| | a. | Transaction ID |
| | b. | Description |
| | c. | Date/Time |
| | d. | Type |
| | e. | Advertiser/Note Owner ID |
| | f. | Advertisement/Note Owner Rules Used 1-N |
| | g. | Billing T&C's 1-N |
| | h. | Billing Method ID |
| | i. | Transaction Amount |
| | j. | Results 1-N |

| | |
|---|---|
| 1. | Note Added, Changed, Deleted, and/or Accessed |
| 2. | Hyperlink Clicked |
| 3. | Sub-Hyperlinks Clicked 1-N |

| | |
|---|---|
| a. | Advertisement/Note and/or Webpage) Displayed 1-N |
| b. | Click Through y/n |
| c. | Duration of view |
| d. | Conversion y/n |
| e. | Conversion dollar amount |

| | k. | Notes 1-N |
|---|---|---|
| 10. | Advertisement Database | |
| | a. | Advertisement ID |
| | b. | Advertiser ID |
| | c. | Description |
| | d. | Words 1-N |
| | e. | Documents 1-N |
| | f. | Hyperlinks 1-N |
| | g. | Advertising Content File 1-N |
| | h. | Notes ID 1-N |
| 11. | Document Class Database | |
| | a. | Class ID |
| | b. | Description |
| | c. | Notes 1-N |
| 12. | Document Sub Class Database | |
| | a. | Subclass ID |
| | b. | Description |
| | c. | Notes 1-N |
| 13. | Document Type Database | |
| | a. | Type ID |
| | b. | Description |
| | c. | Notes 1-N |
| 14. | Document Sub Type Database | |
| | a. | Subtype ID |
| | b. | Description |
| | c. | Notes 1-N |
| 15. | Group Database | |
| | a. | Group ID |
| | b. | Description |
| | c. | Notes 1-N |
| 16. | Advertisement Type Database | |
| | a. | Type ID |
| | b. | Description |
| | c. | Notes 1-N |
| 17. | Word Count Database | |
| | a. | Word ID |
| | b. | Number of Occurrences |
| | c. | Hyperlinks 1-N |
| | d. | Notes 1-N |
| 18. | Survey Database | |
| | a. | Survey ID |
| | b. | Survey Description |
| | c. | Advertiser ID |
| | d. | Survey Question ID 1-N |

| | |
|---|---|
| 1. | Question |
| 2. | Answer Options 1-N |

| | e. | Notes 1-N |
|---|---|---|
| 19. | Results Database | |
| | a. | Result ID |
| | b. | End User ID |
| | c. | Survey Questions 1-N |
| | d. | Survey Answers 1-N |
| | e. | Date/Time Stamp |
| | f. | Narrative or Text Responses 1-N |
| | g. | Notes 1-N |
| 20. | Rules Database | |
| | a. | Rule ID |
| | b. | Rule Description |
| | c. | Rules 1-N |
| 21. | Search and Survey Database | |
| 22. | Word Descriptor Database | |
| 23. | Notes Database | |
| | a. | Note ID |

| | |
|---|---|
| 1. | Hyperlinks 1-N |
| 2. | Note Description Short |
| 3. | Note Description Long |
| 4. | Note Group ID |
| 5. | Note Class ID |
| 6. | Note Subclass ID |
| 7. | Note and/or Note Attachments 1-N |

| | |
|---|---|
| a. | Owner/Submitted By ID |
| b. | Original Submission Date/Time |

| | |
|---|---|
| b. | Modifications 1-N |

| | |
|---|---|
| 1. | Owner/Submitted By ID |
| 2. | Modification Submission Date |
| 3. | Short Description |
| 4. | Long Description |

| | |
|---|---|
| a. | Owner/Submitted By ID |
| b. | Original Submission Date/Time |
| c. | Hyperlinks 1-N |
| d. | Change Image 1-N |

| | |
|---|---|
| i. | Before Change |
| ii. | After Change |

| 24. | Suppression Rules Database | |
|---|---|---|
| 25. | Hyperlink Database | |
| | a. | Hyperlink ID |
| | b. | Hyperlink |
| | c. | Description |
| | d. | Owner ID |
| | e. | Advertiser ID |
| | f. | Notes 1-N |
| 26. | User Database | |
| | a. | User ID |
| | b. | Name |
| | c. | Account Type |
| | d. | Description |
| | e. | Terms and Conditions ID |
| | f. | Text |
| | g. | Notes 1-N |
| 27. | Document Group Database | |
| | a. | Group ID |
| | b. | Description |
| | c. | Includes Sub-Groups/Sub-Class IDs 1-n |
| | d. | Notes 1-N |
| 28. | Document Class | |
| | a. | Class ID |
| | b. | Description |
| | c. | Includes Sub-Class IDs 1-N |
| | d. | Notes 1-N |
| 29. | Document Sub Class | |
| | a. | Subclass ID |
| | b. | Description |
| | c. | Notes 1-N |
| 30. | Note Class | |
| | a. | Note Class ID |
| | b. | Description |
| | c. | Includes Sub-Class IDs 1-N |
| | d. | Notes 1-N |
| 31. | Note Subclass | |
| | a. | Note Subclass ID |
| | b. | Description |
| | c. | Notes 1-N |
| 32. | Nick Name Database | |
| | a. | Nick Name ID |
| | b. | Nick Name (Short Description) |
| | c. | Nick Name (Long Description) |
| | d. | Patent or Document Number |
| | e. | Notes 1-N |
| 33. | Patent Application or Document ID Database | |
| | a. | Patent or Document ID # |
| | b. | Hyperlinks 1-N (e.g., Link to that patent on different websites) |
| | c. | Notes 1-N |
| 34. | Alert Event Rules Database | |
| | a. | Alert Event Rule ID |
| | b. | Alert Event Description |
| | c. | Alert Event Rules 1-N |

| | |
|---|---|
| 1. | Event Condition |
| 2. | Alert Recipient ID 1-N |

| | |
|---|---|
| a. | Alert Method 1-N |

| | |
|---|---|
| 3. | Alert Database ID 1-N |

| | d. | Notes 1-N |
|---|---|---|
| 35. | Alert Database | |
| | a. | Alert Database ID |
| | b. | Alert Contents, one or more of: |

| | |
|---|---|
| 1. | Text |
| 2. | Variable Data |
| 3. | Executable |

| | c. | Notes 1-N |
|---|---|---|
| 36. | Alert Methods Database | |
| | a. | Alert Method ID |
| | b. | Method Type |
| | c. | Delivery Method (cell phone, pager, e-mail, PDA, database, |
| | | executable, etc.) |
| | d. | Notes 1-N |
| 37. | Alert Recipient Database | |
| | a. | Alert Recipient ID (e.g., end user ID) |
| | b. | Description |
| | c. | Alert Method Preferences ID 1-N |
| | d. | Notes 1-N |

It will be appreciated that the various software and hardware components described above will be configured to perform a variety of functions and methods. Listed below are some exemplary methods that might be performed by the systems as described herein:
1. Select Words
   a. Load Databases
   b. Determine Advertisers
   c. Determine Word Lists
   d. Search Databases
   e. Determine Words To Link to Advertisements
   f. Determine Advertisements to Link to Words
   g. Create Hyperlinks to Words
   h. Update Databases
2. Track Clicks
   a. Load Databases
   b. Receive Indication of End User Click on Hyperlink
   c. Redirect End User as required/indicated
   d. Store Click Activity and Results
   e. Update Database
3. Bill for Clicks
   a. Load Databases
   b. Determine Number/Type of Clicks by Advertiser
   c. Determine Fees for Clicks
   d. Create Invoice
   e. Send Invoice to Advertiser
   f. Update Databases
4. Determine Conversion
   a. Receive a click on an advertisement
   b. Receive an indication that a conversion has happened from the click
   c. Store click and conversion
   d. Retrieve clicks and conversion in a given time period
   e. Generate and Store Conversion rate
5. Optimize Clicks
   a. Receive and Store click data for keyword advertisements
   b. Retrieve click rate data for various keyword clicks for a period of time
   c. Categorize clicks in order of success
   d. Generate queue or rules for placing later click advertisements based on keyword click success data
   e. Output keywords on subsequent searches based on click success criteria
6. Optimize Conversion
   a. Retrieve conversion rate data for various keyword clicks for a period of time
   b. Categorize conversions in order of success
   c. Generate queue or rules for placing later click advertisements based on keyword conversion success data
   d. Output keywords on subsequent searches based on conversion success criteria
7. Bill for Conversion
   a. Load Databases
   b. Determine Number/Type of Conversions by Advertiser
   c. Determine Fees for Clicks
   d. Create Invoice
   e. Send Invoice to Advertiser
   f. Update Databases Create Word List Automated
   g. Load Databases
   h. Retrieve Synonyms and/or Antonyms
   i. Determine Initial Relevancy Score
   j. Update Databases
8. Create Word List Manual
   a. Load Databases
   b. Receive request to add/change/delete records
   c. Retrieve Synonyms and/or Antonym submissions
   d. If required, await approval of submissions
   e. If approved, determine Initial Relevancy Score
   f. Update Databases
   g. Select Figures and Associate Advertisements to Figures
   h. Load Databases
   i. Retrieve Figure Database Names
   j. Determine Words
   k. Determine Applicable Advertisements
   l. Create Hyperlinks
   m. Update Databases
9. Create Word Hierarchy
   a. Generate and Store word count and/or word search data
   b. If applicable divide word counts by document class and subclass
   c. Sort words by word count and/or word search data
   d. Store word sort.
10. Create Word Groups
   a. Generate word count occurrences of two or more words in documents that may be sorted by classes and subclasses
   b. Score words based on occurrences of two or more words in a document
   c. Create groups of words based on occurrence score and/or class and subclasses of documents where words occur
11. Create Advertisement Type
   a. Retrieve a word or word group
   b. Receive or Generate an advertisement type that is associated with the word or word group
   c. Store advertisement type
12. Create Document Word Count
   a. Load Databases
   b. Search Documents
   c. Count words requested by advertisers and/or included in documents
   d. Update databases p1 13. Create Word Click/Display Count
   a. Load Databases
   b. Receive Indication of End User Click Through
   c. Determine if Advertisement is Displayed/Viewed
   d. Update Databases
14. Create Survey
   a. Load Databases
   b. Determine Questions
   c. Associate Questions with Hyperlinks
   d. Update Databases Output Survey
   e. Load Databases
   f. Receive Indication of End User Click
   g. Determine if Survey Required
   h. If yes, present questions
   i. Receive end user responses
   j. Determine if responses affect hyperlink action outcome
   k. Redirect end user to appropriate hyperlink(s) or action(s)
   l. Execute Billing Applications (e.g., click through and/or conversion billing)
   m. Update Databases
15. Use Survey To Optimize word display, click, and conversion results
   a. Retrieve one more more completed surveys
   b. Score word display, click, and conversion results based on survey answers
   c. Store Scores
   d. Optimize and store word display rules based on scores.
16. Determine Advertisement Hyperlink for a displayed word
   a. Receive a keyword search
   b. Retrieve at least one document to display in response to keyword search
   c. Determine words in document that have corresponding advertisements
   d. Determine advertisement type
   e. Generate appropriate hyperlink to word based on advertisement type
   f. Output document with appropriate word hyperlinks
17. Create Survey to Provide More Information when Searchers Clicks on Hyperlink Word
   a. Receive a keyword search
   b. Output at least one document with at least one keyword hyperlink
   c. Receive a click on the hyperlink
   d. Generate and Output a survey in response to the keyword search and the hyperlink click
   e. Receive answers to the survey
   f. Generate one or more advertisements to display based on keyword search, hyperlink click, and survey answers.
18. Determine Advertisement List/Ranking/Queue for a hyperlinked word
   a. Receive a keyword search
   b. Generate at least one document with at least one hyperlink word in response to the keyword search
   c. Determine at least two advertisements that are appropriate to display in response to clicking on the hyperlink.
   d. Determine advertisement priority based on advertisement queue rules
   e. Display advertisements in order of priority when hyperlink is pressed
19. Create Priority of Words
   a. Receive a request to display an advertisement in response to clicking on one of a group of two or more words
   b. Receive a priority ranking of the words
   c. Store words with associated advertisement and priority ranking
20. Create Text Descriptors for Words
   a. Receive a request to describe a word including a word, and a document class and subclass
   b. Output descriptor form
   c. Receive description
   d. Store description with word and document class/subclass
21. Display Text Descriptors for Words
   a. Receive a keyword search
   b. Generate at least one document with at least one word hyperlink in response to the keyword search
   c. Determine text descriptor for hyperlinked word
   d. Output document
   e. Receive click on hyperlink
   f. Output text descriptor of word in response to hyperlink click
22. Create Synonyms and Antonyms for Words
   a. Receive a request to create an advertisement for a word
   b. Generate and Output a list of synonyms and antonyms for the word
   c. Receive a request to link advertisement to at least one word listed as a synonym or antonym
   d. Store advertisement with requested word
23. Hyperlink word in document in document drafting tool
   a. Receive a request to use a document drafting tool including a document type, class, and subclass
   b. Receive or generate text to be included in document being drafted
   c. Determine if advertisements exists for words included in text
   d. Generate and output hyperlinks to words in text
   e. Receive a click on a hyperlink
   f. Display advertisement associated with hyperlinked word.
24. Hyperlink word in lexicon
   a. Receive a request to use a lexicon including a document class and subclass
   b. Display words in lexicon with corresponding definitions
   c. Determine if advertisements are available for displayed words
   d. Create hyperlinks to advertisements from displayed words
   e. Receive a click on a hyperlink
   f. Display advertisement associated with hyperlink

Or Event Driven Model:

Create Maintain Databases
1. Initially populate or create empty databases
2. Update Databases

Primary Application
3. Load Databases
4. Receive indication that one or more applications/routines should be executed periodically, upon request, continually or based upon other indicator(s)
5. Execute such one or more applications/routines as desired/necessary
6. Update Databases

User Interface Application
1. Load database(s)
2. Display graphical user interface for each application/feature as requested/desired
3. Receive input or requests from applications, modules and/or end users
4. Execute functions as requested/required and/or load additional applications/GUIs
5. Update databases

Opt In/Sign Up Application
1. Load Databases
2. Receiving indication of new user sign up
3. Record any and all or available information regarding one or more end users, merchants, advertisers, examiners, attorneys and/or third parties
4. Update databases

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Document Database Index Program
1. Load Databases
2. Determine available or participating documents
3. Periodically search all available/participating documents
4. Create/update index for all found (or participating) documents/words/synonyms
5. Receive indication of add/change/delete request(s)
6. If required, queue and review request(s)
7. If required, approved request(s)
8. Create/update document databases
9. Update databases

Words Index Program
1. Load Databases
2. Search/Index all available documents
3. Create/update index for all words
4. Create/update/insert or maintain hyperlinks for all indexed words
5. Receive indication of add/change/delete request(s)
6. If required, queue and review request(s)
7. If required, approved request(s)
8. Determine and incorporate synonyms into index
9. Create/update word database
10. Update databases

Create/Maintain Advertising Database
1. Load Databases
2. Receive request to display one or more databases/words
3. Search for such databases/words
4. Display databases/words—sort and/or filter based upon end user preferences and/or survey responses—optionally use groups, classes or subclasses to sort/display information
5. Receive request to add or maintain or delete one or more advertisements
6. Determine word/document/hyperlink availability for ad insertion
7. Determine pricing for advertisements
8. If applicable, bill and/or collect and/or accrue fees
9. Create/update index for one or more advertisements
10. If required, queue and review request(s)
11. If required, approved request(s)
12. Insert advertising hyperlink to word or document database and/or source material
13. Create/update advertising databases
14. Update databases

Advertisement Creation/Submission Application
1. Load Database(s)
2. Display advertising creation/modification/submission GUI
3. Receive request to add/change/delete one or more advertisements
4. Receive advertisement or advertisement hyperlink contents and associate with one or more words, synonyms, antonyms and/or figures and/or documents
5. Determine if such one or more words, synonyms, antonyms, figures and/or documents have pre-existing hyperlinks by current or third party end user or otherwise
6. If not, determine price to associate hyperlink as applicable
7. If one or more similar hyperlinks already exist, execute hyperlink bid pricing application
8. If approved and priced, insert or otherwise associate said hyperlink with said one or more words, synonyms, antonyms, figures and/or documents.
9. Update Database(s)

Merchant/Advertiser Budget Program
1. Load Database(s)
2. Receive indication from advertiser for advertising budget, spending limits
3. Create budget/spending rules
4. Update Database(s)

Hyperlink Pricing Program
1. Load Database(s)
2. Receive pricing request
3. Determine if more than one user wishes a hyperlink to the same or similar word(s), synonym(s), antonym(s), figure(s) and/or documents
4. Determine pricing and/or auction hyperlink, or, if applicable, position in list of two or more hyperlinks
5. Notify affected parties, e.g., via an alert
6. Receive indication from one or more users as to willingness to pay and price points
7. Continue process until pricing is determined
8. Receive authorization for final pricing from affected parties, including end users
9. Update Database(s)

Advertisement Viewing/Use Application
1. Load Database(s)
2. Receive request to display or access advertisement, e.g., user clicks hyperlink or right clicks word
3. Determine if additional browser page or popup or other display method is to be used
4. Display Advertisement, e.g., load and display attached movie file
5. Determine if survey should be presented
6. Present survey
7. Determine if secondary or different advertisement is to be displayed
8. Display advertisement
9. Collect usage information, e.g., impressions for thesaurus relevancy and/or advertising/hyperlink click-through and/or conversion improvement and/or billing purposes
10. Execute billing program
11. Modify relevancy scores as determined by word, database and/or other application usage and/or using end user feedback
12. Update Database(s)

Word Definition/Synonym/Antonym/Figure/Document Lookup Tool
1. Load Database(s)
2. Receive request from advertising, hyperlink, drafting or third party display tool for word, definition, synonym, antonym, figure and/or document display (any one or any combination or all of the forgoing)
3. Determine relevancy information
4. Retrieve requested information, using relevancy information if applicable/available
5. Determine if additional browser page or popup or other display method is to be used (e.g., interstitial popup window)
6. Determine if application and/or end user has requested filter and/or sort and/or relevancy options
7. Display or Store Requested Information (using filter, sort and/or relevancy information and/or filter criteria if applicable// available)
8. Determine if survey should be presented
9. If presented, gather survey results
10. Determine if advertisement or supplemental information should be displayed
11. Display advertisement or supplemental information as indicated
12. Determine if relevancy information should be modified based upon any one or more of such surveys, advertisements, end user usage or any combination of these
13. Update Database(s)

Billing Program
1. Load Database(s)
2. Receive indication that billing activity has occurred
3. Determine affected parties, e.g., payer and payee
4. Determine billing rules, terms and conditions
5. Determine billing amounts due
6. Create Invoice and A/P or A/R notices/entries
7. Send Invoices and notices
8. Update Databases
9. Await Payment
10. Receive payment indication
11. Apply payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Create/Maintain Thesaurus
1. Load Databases
2. Create initial thesaurus by populating all known words
3. Periodically import known synonyms/antonyms
4. Receive add/change/delete and/or notes add/change/delete request
5. If required, queue and review request(s) and/or imported entries and/or notes
6. If required, approved request(s) and/or imported entries and/or notes
7. Add/Change/Delete synonym or antonym and/or entries and/or notes
8. If desired, add hyperlink in source or other databases to reference either or both the source word and/or the synonym or antonym and/or notes as applicable
9. Create/update thesaurus database
10. Update databases

Advertisement/Hyperlink Review Program
1. Load Databases
2. Determine Ad/Hyperlink Use/Effectiveness
3. Replace one or more underperforming ads/hyperlinks with one or more replacement hyperlinks
4. Monitor results of replacement ads/hyperlinks
5. Update effectiveness modeling or genetic algorithm
6. Update Databases

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a database of documents;
receiving compensation from a first entity to allow the entity to select indicia that might appear in the documents in the database to hyperlink to a second document that is not in the database;
hyperlinking the word to the second document; and
providing the database including the hyperlinked word to one or more users.

2. The method of claim 1 wherein receiving compensation comprises determining a fee structure based, at least in part, on the number of appearances of the indicia in the database.

3. The method of claim 1 wherein receiving compensation comprises determining a fee structure based, at least in part, on the position of the indicia in the documents in the database.

4. The method of claim 1 wherein the documents are patent documents.

5. The method of claim 1 wherein the indicia is a word.

6. The method of claim 1 wherein the indicia is a phrase.

7. The method of claim 1 wherein the indicia is an image.

8. The method of claim 1 wherein the indicia is a drawing.

9. The method of claim 1 further comprising indexing the words in the documents in the database.

10. The method of claim 9 further comprising creating an indexed list of the words in the documents in the database.

11. The method of claim 10 further comprising providing the list to the first entity and allowing the entity to select a word or phrase from the list.

12. A system comprising:
a database comprising a plurality of documents wherein the plurality of documents comprising a plurality of indicia; and
hyperlinks associated with at least some of the indicia in the documents, wherein the hyperlinks point to one or more documents that are not contained in the database;
a billing system configured to receive compensation for the placement of the hyperlinks in the documents in the database.

13. The system of claim 12 wherein the documents are issued patents and published patent applications.

14. The system of claim 12 wherein the indicia are words.

15. The system of claim 12 wherein the indicia are phrases.

16. The system of claim 12 wherein the indicia are images.

17. The system of claim 12 further comprising a user-interface wherein an entity can select indicia in the documents to be hyperlinked.

18. The system of claim 17 wherein the user-interface further comprises a mechanism by which the entity can indicate the document not in the database to which the indicia is to be hyperlinked.

19. The system of claim 18 wherein the document not in the database is a web-based advertisement.

20. The system of claim 12 wherein the document not in the database is a website.
